(19) United States
(12) Patent Application Publication
(10) Pub. No.: US 2014/0082393 A1
(43) Pub. Date: Mar. 20, 2014

(54) Hot Swapping Type Uninterruptible Power Supply Module

(71) Applicants: Super Micro Computer Inc., New Taipei City (TW); CompuwareTechnology Inc., New Taipei City (TW)

(72) Inventor: Chien-Ta Liang, New Taipei City (TW)

(73) Assignees: Super Micro Computer Inc., New Taipei City (TW); Compuware Technology Inc., New Taipei City (TW)

(21) Appl. No.: 13/895,398

(22) Filed: May 16, 2013

(30) Foreign Application Priority Data
Sep. 14, 2012 (TW) 101217876

(51) Int. Cl. G06F 1/32

(52) U.S. Cl. CPC G06F 1/3212
USPC 713/323

(57) ABSTRACT

A system comprises a plurality of the hot swapping type uninterruptible power supply module and a plurality of conventional power supply. A HSUPS comprises a battery module and a controller module. A conventional power supplies is connected with an external AC power source and converts into DC voltage to provide power to the electronic system and/or to charge the HSUPS when necessary. The battery module holds the energy needed to power the electronic system during the absences of a conventional power supply and/or external AC power source. The controller module controls the operation to charge the battery, discharge the battery, switch off the HSUPS, or be standby. The controller module has the ability to detect for any failure event. The HSUPS provides power to the electronic system when the external AC power source is interrupted and when all of the conventional power supplies are removed from the system.

### BACKGROUND OF THE INVENTION

1. Field of the Invention

The present invention relates to an uninterruptible power supply module and, more particularly, to a hot swapping (or hot plugging) type uninterruptible power supply module.

2. Description of the Related Art

A conventional computer server is powered by an external alternating-current (AC) power source. When the AC power source is interrupted or insufficient for any possible reason, the computer server operation can be affected and lead to an unexpected system shutdown or service interruption. One of the solutions to prevent such interruption is to use an external uninterruptible power supply (UPS). The use of UPS has a few disadvantages including: the need of additional external space for the installation of the UPS, interruption of computer server operation during installation or maintenance, and the reduced energy efficiency due to the power and voltage conversion by the UPS.

### BRIEF SUMMARY OF THE INVENTION

In accordance with the present invention, there is provided a hot swapping type uninterruptible power supply module (HSUPS), comprising of a battery module and a controller module. In application, a conventional power supplies is connected with an external alternating-current(AC) power source and converts the alternating-current (AC) voltage into a direct-current (DC) voltage to provide an electric power to the electronic system and/or to charge the HSUPS when necessary. The battery module of the HSUPS holds the energy needed to power the electronic system during the absences of a conventional power supply and/or external AC power source to the conventional power supply. The controller module of the HSUPS controls the HSUPS operation. It determines whether the HSUPS should charge or discharge the battery module, switch off the HSUPS, or be in standby. The controller module has the ability to receive signals to detect for an AC lost, any conventional power supply absences, and conventional power supply failure event. The controller module can engage a discharge function to power the electronic system as necessary. The controller module also regulates and controls the voltage level needed to charge the battery module or to discharge to power the electronic system. The charging and discharging interface is bi-directional meaning that the charging and discharging power transfer through the same interface and channel. The HSUPS has the ability to be installed, removed and maintained without interrupting and affecting the electronic system, any other connected HSUPS, or any connected conventional power supply.

Preferably, the battery contains rechargeable type batteries, such as lithium-ion batteries.

Preferably, the HSUPS can work together along with multiple HSUPS to enhance the battery module energy capacity and provide redundancy.

According to the primary advantage of the present invention, the HSUPS provides an electric power to the electronic system successively when the external power source is interrupted or fails, or the conventional power supply has failed or being absences.

According to another advantage of the present invention, the hot swapping uninterruptible power supply module supports a hot swapping (or hot plugging) function that allows the installation, removal, and maintenance of the HSUPS without affecting the operations of any other connected HSUPS, conventional power supplies, or the electronic systems.

### BRIEF DESCRIPTION OF THE SEVERAL VIEWS OF THE DRAWING(S)

FIG. 1 is a block diagram of a hot swapping type uninterruptible power supply module in accordance with the preferred embodiment of the present invention.

FIG. 2 is a flow chart of the control and operation of the hot swapping type uninterruptible power supply module as shown in FIG. 1.

FIG. 3 is a flow chart of a charging mode of the hot swapping type uninterruptible power supply module.

FIG. 4 is a flow chart of a discharging mode of the hot swapping type uninterruptible power supply module.

### DETAILED DESCRIPTION OF THE INVENTION

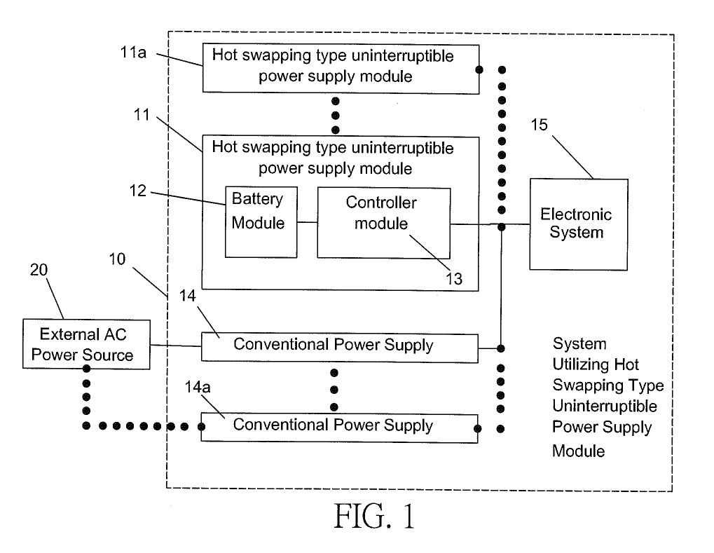

Referring to the drawings and initially to FIG. 1, a system 10 utilizing a hot swapping type uninterruptible power supply module in accordance with the preferred embodiment of the present invention comprises a plurality of the hot swapping type uninterruptible power supply module (HSUPS) 11 and 11a, and a plurality of conventional power supply units 14 and 14a. The HSUPS 11, 11a, and conventional power supplies 14, 14a are connected together electrically.

At least one of the HSUPS 11 and 11a, and at least one of the conventional power supply 14 and 14a are connected electrically with an electronic system 15 (such as a motherboard or computer devices or the like). The conventional power supply 14 and 14a are connected to an external alternating-current power source 20 individually and convert the alternating-current voltage into a direct-current voltage to provide an electric power to the electronic system 15 and when necessary, provide charging energy to the HSUPS 11 and 11a.

Each of the HSUPS 11 and 11a has a battery module 12 and a controller module 13. The battery module 12 preferably comprises of rechargeable type batteries, such as lithium-ion batteries. The controller module preferably contains electronic circuits to control the charging, discharging action of the battery module.

The controller module 13 comprises of electronic circuits and integrated circuit components that have the ability to determine whether the HSUPS 11 should charge the battery module 12, discharge the battery module 12, switch off the HSUPS 11, or be standby. The controller module 13 has the ability to receive signals from the conventional power supply 14 and 14a to detect for the external AC power source 20 lost, the absences or failure of the conventional power supply 14 and 14a. With that ability, the controller module 13 can engage the discharge function to power the electronic system 15 in order to prevent interruption to the system 10 operations. The controller module 12 also regulates and controls the voltage level needed to charge the battery module 12 or to discharge to the electronic system 15. Multiple HSUPS 11 and 11a can be installed in the same system 10 to increase the battery charge capacity and to provide hardware redundancy. Multiple conventional power supply 14 and 14a can also be installed in the system 10 to provide hardware redundancy and/or to increase the power output capacity to the electronic system 15. At least one of the HSUPS 11 or one of the conventional power supplies must be installed in the system 10 in order to keep the system operational.

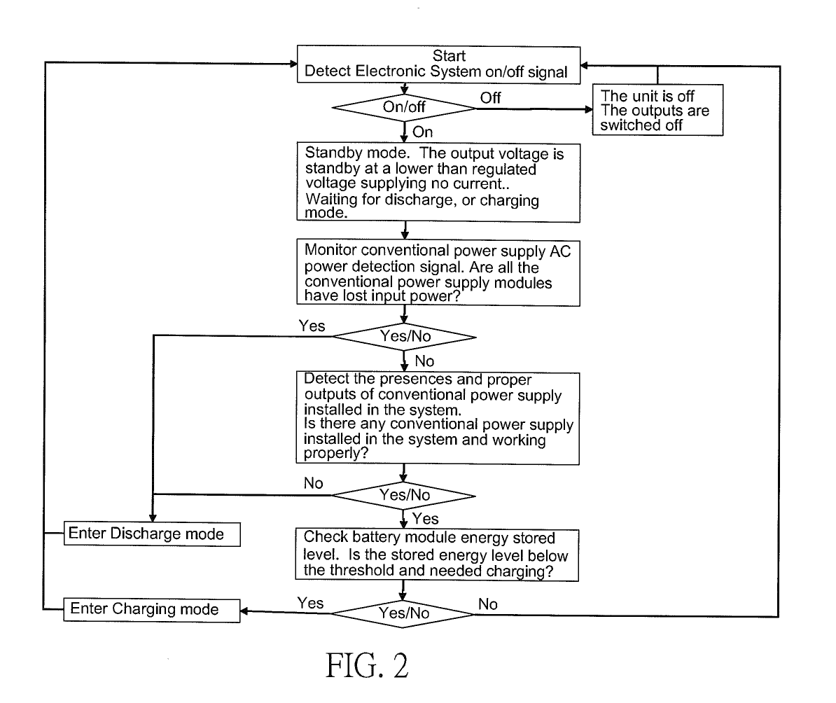

Referring to FIG. 2 with reference to FIG. 1, FIG. 2 shows the flow chart for the controller module 13 to determine its operating mode. In practice, the controller module 13 initially detects the on/off signal from the electronic system connected. When the electronic system is off, the HSUPS will be turned off and all outputs, charging or discharging actions are suspended. When the electronic system is on, the HSUPS will first enter a standby mode and begin determining whether it should enter charging, discharge, or remain in standby mode. The engagement of discharging mode is a top priority process meaning that the discharge can engage immediately as necessary in order to warrant the uninterrupted power providing to the electronic system 10. The conditions that can engage discharge mode by satisfying at least one of the below three conditions: 1) all the conventional power supply modules 14 and 14a installed have lost input alternating-current power from the external alternating-current power source 20. 2) all the conventional power supply modules 14 and 14a have been removed from the system 10. 3) all the conventional power supply modules 14 and 14a have failed to provide proper output to the electronic system 15. When the HSUPS 11 and 11a is not discharging and when the battery module 12 stored energy level is below a threshold, example 85%, the controller module would determine to begin the charging mode.

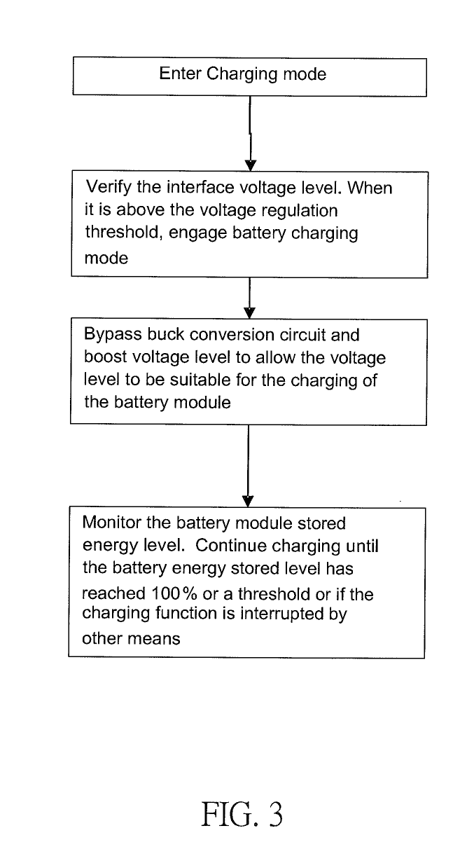

Referring to FIG. 3 with reference to FIG. 1 and FIG. 2, FIG. 3 shows the flow chart for the HSUPS 11 and 11a to operate in the charging mode. The controller module 13 verify the direct current voltage supplied by the connected conventional power supply 14 and 14a are above a certain threshold, example 11.4V. The controller module 13 controls the circuit to bypass the buck converter and to enable the boost converter to increase the supplied voltage from the conventional power supply 14 and 14a to allow charging of the battery module 12. The controller module 13 monitors the battery module 12 charging status and will suspend the charging when the battery module 12 is fully charged or has reached a stored energy level threshold.

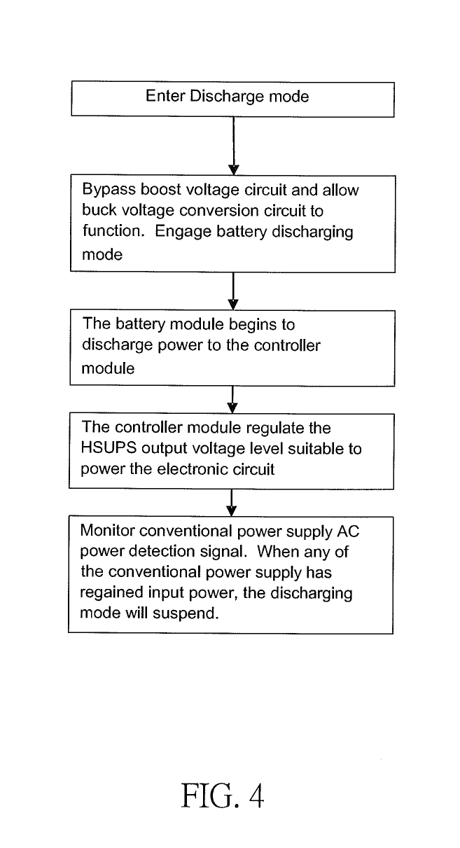

Referring to FIG. 4 with reference to FIG. 1 and FIG. 2, FIG. 4 shows the flow chart for the HSUPS 11 and 11a to operate in the discharging mode. The controller module 13 controls the circuit to bypass the boost converter and enable the buck converter to convert from the energy stored in the battery module 12, to a direct current voltage that can power the electronic system 15. The discharge is suspended when all the stored energy in the battery module 12 is depleted or any of the conventional power supply module 14 and 14a has regained power from external AC power source 20 and can provide proper output power to the electronic system 15. When the HSUPS begins discharging due to the failure of the conventional power supply 14 and 14a, a replacement and restoration of power by the conventional power supply 14 and 14a can also suspend the discharge function.

1. A system utilizing hot swapping type uninterruptible power supply module, comprising:
a plurality of hot swapping type uninterruptible power supply modules, and a plurality of conventional power supply units; wherein:
at least one of the conventional power supply module is connected electrically with an electronic system and an external alternating-current power source and converts the alternating-current voltage of the external alternating-current power source into a direct-current voltage to provide an electric power to the electronic system;
at least one of the hot swapping type uninterruptible power supply module comprises of a battery module and a controller module;
the battery module is connected electrically with the controller module and stores and provides the energy needed to operate the electronic system;
the controller is connected electrically with the electronic system and the battery module to control the charging and discharging actions of the battery module;
the controller detects and controls the electric power of the battery module; and
the controller has a power interruption detection capability.

2. The hot swapping type uninterruptible power supply module of claim 1, wherein the direct-current voltage of at least one of the conventional power supplies is transformed to directly charge the battery module.

3. The hot swapping type uninterruptible power supply module of claim 1, wherein the battery module comprises of rechargeable batteries.

4. The hot swapping type uninterruptible power supply module of claim 2, wherein with the installation or removal of any hot swapping type uninterruptible power supply, the electronic system operation is unaffected.

5. The hot swapping type uninterruptible power supply module of claim 2, wherein with installation or removal of any conventional power supply module, the electronic system operation is unaffected.

6. The hot swapping type uninterruptible power supply module of claim 2, wherein the controller module detects and inspects the hot plugging status of each of the conventional power supplies and the hot swapping type uninterruptible power supply modules.

7. The hot swapping type uninterruptible power supply module of claim 2, wherein the charging and discharging share the same bi-directional interface bus.
